(19) United States
(12) Patent Application Publication
(10) Pub. No.: US 2017/0086540 A1
(43) Pub. Date: Mar. 30, 2017

(54) METHOD AND ADJUSTABLE RING FOR RELIEVING STRESS

(71) Applicant: Gold Brands Holdings Inc., Los Angeles, CA (US)

(72) Inventor: Guy Benhamou, Los Angeles, CA (US)

(21) Appl. No.: 15/376,517

(22) Filed: Dec. 12, 2016

(51) Int. Cl. A44C 9/00; A61H 39/04; A61H 23/06; A44C 9/02; A44C 25/00

(52) U.S. Cl. CPC A44C 9/0053; A44C 9/02; A44C 25/007; A61H 23/06; A61H 39/04; A61H 2205/065

(57) ABSTRACT

An adjustable jewelry ring comprising: a first elongated member having a first length; a second elongated member having a second length, a second end of the second elongated member being attached to a first end of the first elongated member and a first end of the second elongated member being attached to a first bead; the second elongated member being flexible; a third elongated member having a third length, a second end of the third elongated member being attached to a second end of the first elongated member and a first end of the third elongated member being attached to a second bead; a slider coupling the second and third elongated members, arranged to be slidable to any position along the lengths of the second or third elongated members; wherein the combined lengths of the first, second and third elongated members is comprised between 50 and 150 millimeter.

### TECHNICAL FIELD

This presentation relates to an adjustable ring capable of interacting with reflexology or acupuncture regions of the hand.

### BACKGROUND

Reflexology, also known as zone therapy, is an alternative medicine involving gentle application of pressure to the feet and/or hands. FIG. 1 is a chart showing the bottom/palm side of the left and right hands of a person, along with the regions of the hand that need be interacted with to—according to reflexology—improve the well-being of various body parts of the person. If there seems to be no scientific evidence that reflexology would dramatically improve any medical condition, it remains a pleasant and stress-relieving experience to receive gentle pressure application in chosen reflexology regions of the hand, for example gentle tapping of the regions. However, persons on their own need one hand for applying gentle pressure or tapping on the other hand, thus inconveniently mobilizing both of their hands.

There exists a need for a device that allows applying gentle tapping or pressure on regions of one hand of a user without mobilizing both hands of the user, and a method for allows applying gentle tapping or pressure on regions of one hand of a user without mobilizing both hands of the user.

### SUMMARY

Embodiments of this presentation provides for a ring which, when worn around a finger of one hand of a user, allows applying gentle tapping or pressure on chosen portions of the hand without use of the other hand of the user. According to embodiments of this presentation, the ring has an adjustable circumference length and can be secured/snugly fit around any phalange of any finger of the hand. Embodiments of this presentation also provide a method for relieving stress by applying gentle tapping or pressure on predetermined regions of one hand of a user, without mobilizing both hands of the user.

An embodiment of this presentation relates to an adjustable jewelry ring comprising: a first elongated member having a first length between opposite first and second ends; a second elongated member having a second length between opposite first and second ends, the second end of the second elongated member being attached to the first end of the first elongated member and the first end of the second elongated member being attached to a first bead; the second elongated member being flexible; a third elongated member having a third length between opposite first and second ends, the second end of the third elongated member being attached to the second end of the first elongated member and the first end of the third elongated member being attached to a second bead; a slider coupling the second and third elongated members, arranged to be independently slidable to any position along the lengths of each of the second and third elongated members; wherein the combined lengths of the first, second and third elongated members is comprised between 50 and 150 millimeter.

According to an embodiment of this presentation, the slider comprises a friction element for retaining the slider to the position it is slid to along the lengths of the second or third elongated members.

According to an embodiment of this presentation, at least one of the first and second beads has a weight comprised between 0.4 and 2 grams.

According to an embodiment of this presentation, the first and second beads are beads made of precious or non-precious metal.

According to an embodiment of this presentation, the second and third elongated members are made of precious or non-precious metal.

According to an embodiment of this presentation, the second and third elongated members each comprise a length of chain.

According to an embodiment of this presentation, the first elongated member comprises a length of precious or non-precious metal chain.

According to an embodiment of this presentation, the first elongated member is a rigid metal structure.

According to an embodiment of this presentation, the second and third elongated members have each a cross-section having a largest dimension comprised between 0.6 and 3 millimeter.

According to an embodiment of this presentation, the slider has a height, a width and a length; the second and third elongated members passing through at least one lumen traversing the slider along its length.

According to an embodiment of this presentation, the friction element comprises a resilient element arranged in the at least one lumen.

An embodiment of this presentation relates to a method of relieving stress, comprising: securing around a phalange of a finger of a hand of a user a ring having attached to it a first end of a flexible element, a first bead being attached to a second end of the flexible element, such that when the hand is held vertical with the finger upright the first bead touches a predetermined region of the finger or the hand; wherein the ring has an adjustable circumference length and can be secured around any phalange of any finger of the hand.

According to an embodiment of this presentation, said ring comprises: a first elongated member having a first length between opposite first and second ends; a second elongated member having a second length between opposite first and second ends, the second end of the second elongated member being attached to the first end of the first elongated member and the first end of the second elongated member being attached to said first bead; the second elongated member being flexible; a slider arranged for being slidable to any position along the length of the second elongated member; wherein the slider is coupled to the second end of the first elongated member; and wherein said flexible element is formed by the second elongated member between said bead and said slider.

According to an embodiment of this presentation, the slider comprises a first friction element for retaining the slider to the position it is slid to along the length of the second elongated member.

According to an embodiment of this presentation, the slider is coupled to the second end of the first elongated member by: a third elongated member having a third length between opposite first and second ends, the second end of the third elongated member being attached to the second end of the first elongated member and the first end of the third elongated member being attached to a second bead; the third elongated member being flexible; wherein the slider is arranged for being slidable to any position along the length of the third elongated member; wherein the combined lengths of the first, second and third elongated members is comprised between 50 and 150 millimeter.

According to an embodiment of this presentation, the slider comprises a second friction element for retaining the slider to the position it is slid to along the length of the third elongated member

According to an embodiment of this presentation, the first bead has a weight comprised between 0.4 and 2 grams.

According to an embodiment of this presentation, the first and second beads are beads made of precious or non-precious metal.

According to an embodiment of this presentation, the second and third elongated members are made of precious or non-precious metal.

According to an embodiment of this presentation, the second and third elongated members each comprise a length of chain.

According to an embodiment of this presentation, the first elongated member comprises a length of precious or non-precious metal chain.

According to an embodiment of this presentation, the first elongated member is a rigid metal structure.

According to an embodiment of this presentation, the second and third elongated members have each a cross-section having a largest dimension comprised between 0.6 and 3 millimeter.

According to an embodiment of this presentation, the slider has a height, a width and a length; the second and third elongated members passing through at least one lumen traversing the slider along its length.

According to an embodiment of this presentation, one of the first and second friction elements comprises a resilient element arranged in the at least one lumen.

An embodiment of this presentation comprises an adjustable jewelry ring comprising: a first elongated member having a first length between opposite first and second ends; a second elongated member having a second length between opposite first and second ends, the second end of the second elongated member being attached to the first end of the first elongated member and the first end of the second elongated member being attached to a first bead; the second elongated member being flexible; a slider arranged for being slidable to any position along the length of the second elongated member; wherein the slider is coupled to the second end of the first elongated member.

According to an embodiment of this presentation, the slider comprises a friction element for retaining the slider to the position it is slid to along the length of the second elongated member.

These and other features and advantages will become further apparent from the detailed description and accompanying figures that follow. In the figures and description, numerals indicate the various features; like numerals referring to like features throughout both the drawings and the description.

### BRIEF DESCRIPTION OF THE DRAWINGS

FIG. 1 is a chart showing reflexology regions on the bottom of the left and right hands of a person.

FIG. 2 shows four rings according to embodiments of this presentation worn on the hands of FIG. 1.

FIG. 3 schematically represents a ring according to an embodiment of this presentation.

FIG. 4 schematically represents a ring according to an embodiment of this presentation.

FIG. 5 schematically represents a ring according to an embodiment of this presentation.

FIG. 6 schematically represents a slider of a ring according to an embodiment of this presentation.

FIG. 7 schematically represents a slider of a ring according to an embodiment of this presentation.

FIG. 8 schematically represents a ring according to an embodiment of this presentation secured around a phalange of a finger.

FIG. 9 schematically represents a ring according to an embodiment of this presentation.

FIG. 10 schematically represents a ring according to an embodiment of this presentation.

FIG. 11 schematically represents a ring according to an embodiment of this presentation.

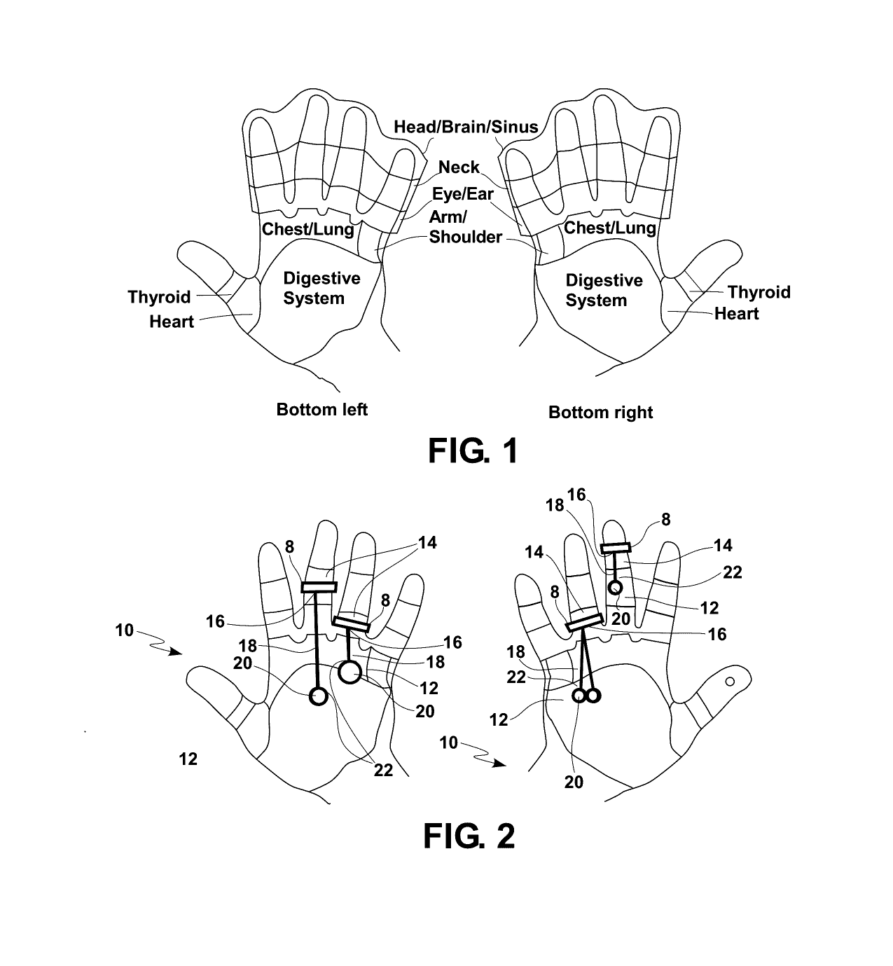

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

FIG. 2 shows four rings 8 according to embodiments of this presentation, worn on the hands 10 of a user, and illustrates a method of relieving stress according to embodiments of this presentation, for applying gentle tapping or pressure on predetermined regions 12 of a first hand 10 of a user without mobilizing both hands of the user. Such method of relieving stress comprises securing around a phalange 14 of a finger of the hand 10 a ring 8, having attached to it a first end 16 of a flexible element 18. A first bead 20 is attached to a second end 22 of the flexible element 18, such that when the hand 10 is held vertical with the finger upright the first bead 20 dangles along the hand and touches a predetermined region of the finger or the hand. The dangling along the hand of the bead 20 attached to ring 8 according to an embodiment of this presentation allows the bead to gently bump against some portions of the hand, thus providing a gentle massage of the bumped portions of the hand in the form of a gentle tap or pressure. In particular, when the hand is held vertical with the finger upright, the first bead 20 gently massages said predetermined region of the finger or the hand, thus providing stress-relief to the user. According to an embodiment of this presentation, the bead can have any appropriate shape. It can be spherical or have tapered ends or have a figurative shape like a stylized heart, flower, clover, dice, etc. . . . According to an embodiment of this presentation, the bead can be a metal bead. According to an embodiment of this presentation, the bead has a weight comprised between 0.4 and 2.0 grams. According to an embodiment, the bead 20 can be as series or strings of beads (not shown).

According to an embodiment of this presentation, the ring 8 has an adjustable circumference length and it can be secured around any phalange 14 of any finger of the hand. Thus, even if the flexible element 18 has a fixed length, the user can position the ring along a desired phalange such that bead 20, at the end of flexible element 18, can bump into and exert gentle massage on a determined region of the hand or finger that is a length of element 18 away from where the ring 8 is secured. According to an embodiment of this presentation, the flexible element 18 can also have an adjustable length as detailed hereafter. Providing a ring having an adjustable circumference has been a long-standing problem, as detailed in the document “Arthritic Finger Joints and Adjustable Rings posted on May 8, 2005 by Fred Klotz on:
http://technical-articles.hooverandstrong.com/wordpress/arthritic-finger-joints-and-adjustable-rings/.
   Embodiments of the present disclosure provide for rings having an adjustable circumference, capable of being secured/snugly fit around any phalange of any finger of any hand of any user. According to embodiments of the present disclosure, the ring can be a jewelry ring and can be made in precious metal.

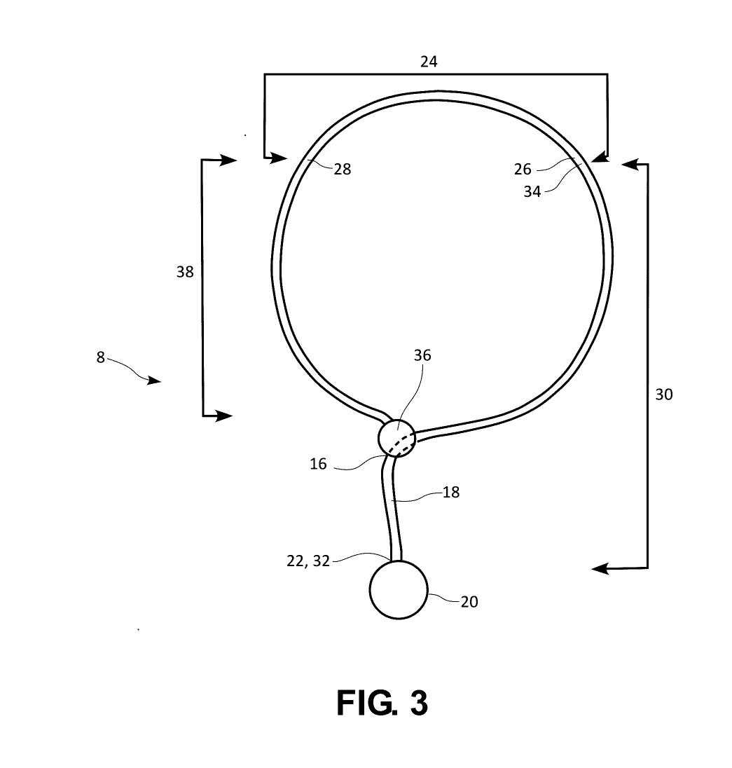

FIG. 3 schematically represents a ring 8 according to an embodiment of this presentation; the ring 8 comprising: a first elongated member 24 having a first length between a first end 16 and a second end 28; a second elongated member 30 having a second length between a first end 32 and a second end 34, the second end 34 of the second elongated member 30 being attached to the first end 26 of the first elongated member 24 and the first end 32 of the second elongated member 30 being attached to bead 20; the second elongated member 30 being flexible. The ring 8 further comprises a slider 36 arranged for being slidable to any position along the length of the second elongated member 30, the slider comprising a first friction element (not shown in FIG. 3) for retaining the slider 36 to any position it is slid to along the length of the second elongated member 30. According to an embodiment of this presentation, the slider 36 is coupled to the second end 28 of the first elongated member 24; and the flexible element 18 of FIG. 2 is formed by the second elongated member 30 between the bead 20 and the slider 36. In the embodiment illustrated in FIG. 3, where the slider 36 is coupled to the second end 28 of the first elongated member 24 via a flexible section 38, the length of element 18 increases as the diameter of the ring 8 decreases. Because the slider 36 comprises a friction element that allows retaining the slider 36 to any position it is slid to along the length of the second elongated member 30, the diameter of ring 8 can be reduced by the user until the ring is gently secured and snugly fit along any position of any phalange of any finger of a hand, thus allowing the user to position bead 20 so that it dangles around, and provides a gentle massage to, a desired region of the hand.

According to an embodiment of this presentation, first elongated member 24, second elongated member 30 and flexible section 38 can have a same structure and/or material, for example have a same chain or wire structure (in metal, precious or not; snake chain, mesh chain, anchor chain, etc. . . . ). According to an embodiment of this presentation, the second elongated member 30 and the flexible section 38 can have a first structure and/or material, for example a same chain or wire structure (in metal, precious or not; snake chain, mesh chain, anchor chain, etc. . . . ), while the first elongated member 24 has another structure and/or material. In such embodiments, the first elongated member 24 can be flexible (such as a length of chain, for example of precious metal) or not (such as a rigid metal structure, eventually carrying one or more precious or semi-precious stones). According to embodiments of this presentation, the second elongated member 30 and the flexible section 38 have each a cross-section with a largest dimension comprised between 0.6 and 3 millimeter.

As detailed hereafter, the slider 36 can be made of metal with at least one lumen lined with a resilient material friction element through which at least the second elongated member 30 passes through.

According to an embodiment of this disclosure, the combined lengths of the first elongated member 24, second elongated member 30 and flexible section 38 is comprised between 40 and 150 millimeter; preferably between 40 and 120 millimeter; preferably between 40 and 75 millimeter.

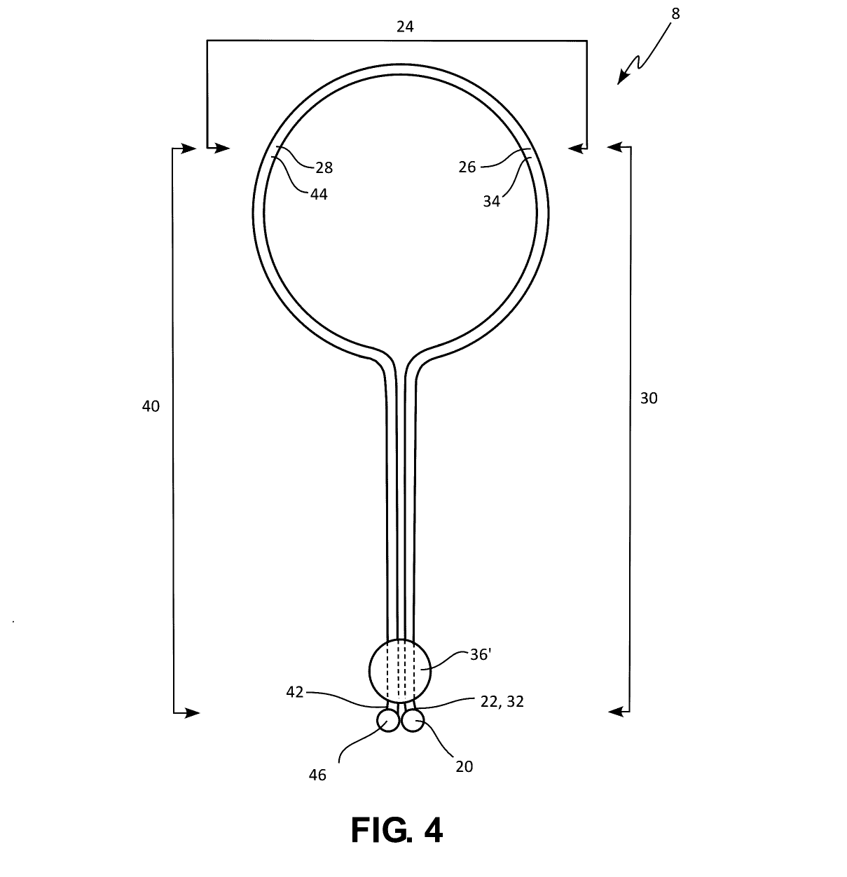

FIG. 4 schematically represents a ring 8 according to an embodiment of this presentation, having a first elongated member 24 and a second elongated member 30 identical to those described in relation with FIG. 3. In the embodiment of FIG. 4 however, the slider 36′ is coupled to the second end 28 of the first elongated member 24 by: a third elongated member 40 having a third length between a first end 42 and a second end 44, the second end 44 of the third elongated member 40 being attached to the second end 28 of the first elongated member and the first end 42 of the third elongated member being attached to a second bead 46; the third elongated member 40 being flexible. According to an embodiment of this disclosure, the second bead 46 can be identical to the first bead 20 as described above, or it can be different from the first bead 20. According to an embodiment of this disclosure, the slider 36′is arranged for being slidable to any position along the length of the third elongated member 40, the slider 36′comprising a second friction element (not shown) for retaining the slider 36′ to the position it is slid to along the length of the third elongated member. According to an embodiment of this disclosure, the second elongated member 30 and the third elongated member 40 can pass through distinct lumens in slider 36′, having each a friction element, or they can pass through a single lumen in slider 36′, having a single friction element. According to

According to an embodiment of this presentation, the second and third elongated member can have a different length or can have a same length. According to an embodiment of this disclosure, the combined lengths of the first elongated member 24, second elongated member 30 and third elongated member 40 is comprised between 50 and 200 millimeter; preferably between 50 and 150 millimeter; preferably between 50 and 100 millimeter.

According to an embodiment of this presentation, first elongated member 24, second elongated member 30 and third elongated member 40 can have a same structure and/or material, for example have a same chain or wire structure (in metal, precious or not; snake chain, mesh chain, anchor chain, etc. . . . ). According to an embodiment of this presentation, the second elongated member 30 and the third elongated member 40 can have a first structure and/or material, for example a same chain or wire structure (in metal, precious or not; snake chain, mesh chain, anchor chain, etc. . . . ), while the first elongated member 24 has another structure and/or material. In such embodiments, the first elongated member 24 can be flexible (such as a length of chain, for example of precious metal) or not (such as a rigid metal structure, eventually carrying one or more precious or semi-precious stones).

According to embodiments of this presentation, the second elongated member 30 and the third elongated member 40 have each a cross-section with a largest dimension comprised between 0.6 and 3 millimeter. According to embodiments of this presentation, the slider 36′ has a height, a width and a length; the second and third elongated members passing through at least one lumen traversing the slider along its length; wherein: the height of the slider is larger than the largest dimension of the largest of the cross section of the second and third elongated members by 1 to 5 millimeters; and the width of the slider is larger than the largest dimension of the added cross section of the second and third elongated members by 1.5 to 7.5 millimeters.

FIG. 4 illustrates an embodiment where the second elongated member 30 and the third elongated member 40 are identical in structure to the first elongated member 24 and have each a cross-section with a largest dimension of 0.6 millimeter; the height (not shown) of the slider 36′ being of 2.2 to 6.2 millimeters; and the width of the slider 36′ being of 2.7 to 8.7 millimeters.

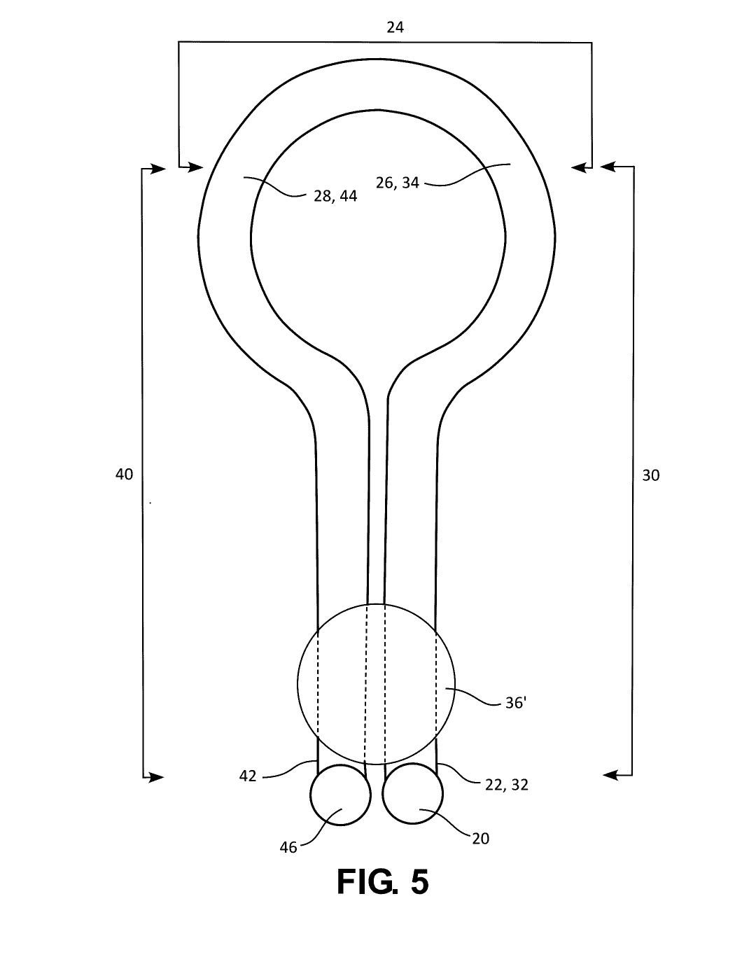

FIG. 5 schematically represents a ring 8 according to an embodiment of this presentation, identical to the ring 8 shown in FIG. 4, but where the second elongated member 30 and the third elongated member 40 are identical in structure to the first elongated member 24 and have each a cross-section with a largest dimension of 3 millimeter; the height (not shown) of the slider 36′ being of 7 to 11 millimeters; and the width of the slider 36′ being of 7.5 to 13.5 millimeters.

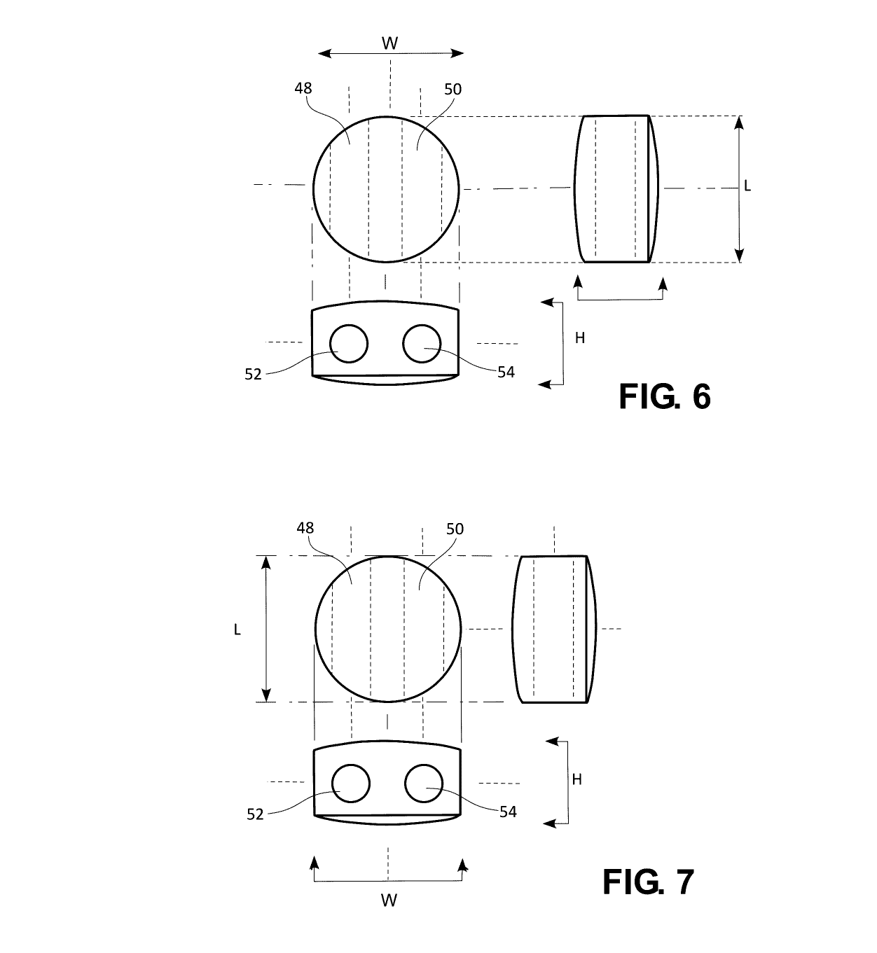

FIG. 6 schematically represents a slider 36′ of the ring 8 shown in FIG. 4. According to an embodiment of this presentation, slider 36′ has a height H, a width W and a length L; the second 30 and third 40 elongated members passing respectively through lumens 48 and 50 traversing the slider 36′ along its length. According to an embodiment of this disclosure, each of lumen 48, 50 is lined with a resilient material friction element 52, 54. In the embodiment of FIG. 6, the largest dimension of the cross-section of second 30 and third 40 elongated members is of 0.6 millimeter; the height H is of 3 millimeters and the width W is of 4 millimeters. The length L is also of 4 millimeters.

According to an embodiment of this presentation (not shown), the slider can comprise two box-like structures of similar cross section, having each an open side. A where a first box like structure is imbricated, open side first, through the open side of the second box-like structure. Each box-like structure comprises at least one hole on opposed sides, such that the elongated members can pass through the imbricated box-like structures through said holes. A resilient element such as a spring is arranged between the two box-like structures so as to push the box-like structures away from each other, thus exerting a shearing force on the elongated members passing through the holes in the opposed sides of each box-like structure. The user can squeeze the slider formed by the imbricated box-like structures to align the holes and release the shearing forces exerted on the elongated members, thus enabling the user to slide effortlessly the slider to any position along any of the second and third elongated members. The friction element can then be the edges of the holes in the sides of the box-like structures.

FIG. 7 schematically represents a slider 36′ of the ring 8 shown in FIG. 5. According to an embodiment of this presentation, slider 36′ has a height H, a width W and a length L; the second 30 and third 40 elongated members passing respectively through lumens 48 and 50 traversing the slider 36′ along its length. According to an embodiment of this disclosure, each of lumen 48, 50 is lined with a resilient material friction element 52, 54. In the embodiment of FIG. 7, the largest dimension of the cross-section of second 30 and third 40 elongated members is of 3 millimeter; the height H is of 7 millimeters and the width W is of 11 millimeters. The length L is also of 11 millimeters.

According to an embodiment of this presentation, the height H of the slider is larger than the largest dimension of the cross section of the largest of second 30 and third 40 elongated members, by 1 to 5 millimeters; and the width W of the slider is larger than the sum of the largest dimensions of the cross section of the second 30 and third 40 elongated members, by 1.5 to 7.5 millimeters. The length L can be smaller than, equal to, or larger than the width W.

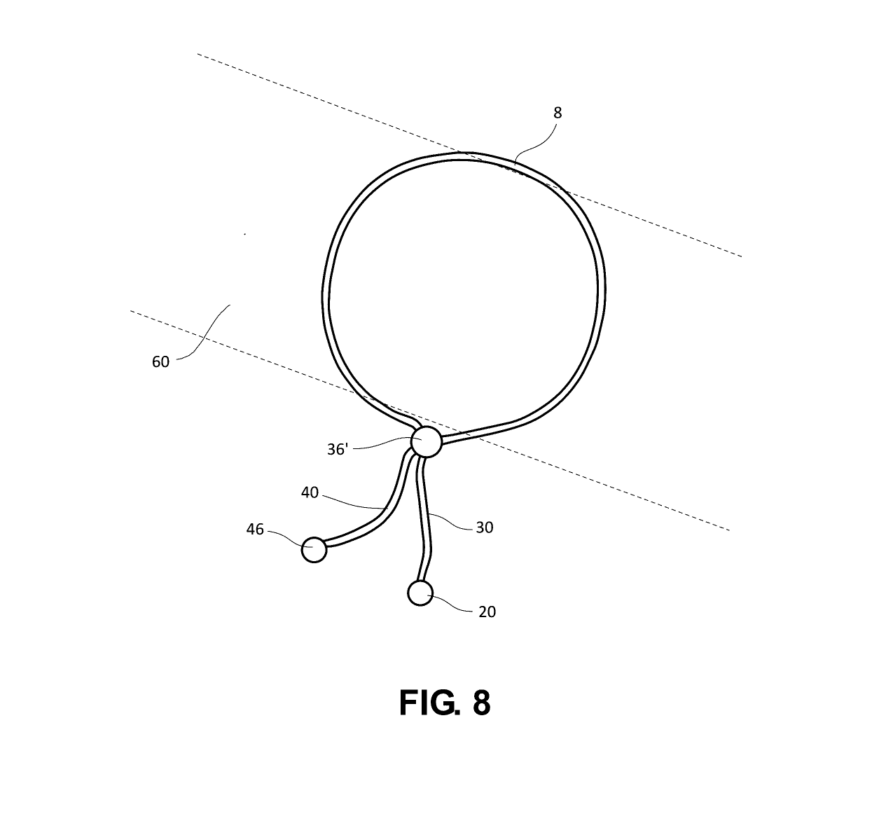

FIG. 8 schematically represents a ring 8 according to an embodiment of this presentation secured, or snugly fit, around a phalange 60 of a finger of a hand of a user. As outlined above, the ring 8 has a circumference length that is adjustable by sliding the slider 36′ along elongated members 30 and/or 40. Slider 36′ has a friction element (not shown in FIG. 8) that allows retaining the slider 36′ to any position it is slid to, along elongated members 30 and/or 40, thus allowing the user to secure the ring 8 around any phalange of any finger of a hand of a user. According to an embodiment of this presentation, the user can, by selectively sliding slider 36′ in a direction rather than another along elongated members 30 and 40, shorten the distance between the slider 36′ and one of beads 46 and 20, while increasing the distance between the slider 36′ and the other of beads 46 and 20, thus allowing the user to fine tune the length of the flexible element of the ring that holds the bead that will gentle tap a desired region of the hand or finger of the user. In FIG. 8, the slider 36′ was moved in a same direction along members 30 and 40, so as to hang the two beads 46, 20 at a same distance of the slider 36′ once the ring 8 is secured around the phalange 60. In FIG. 8, the first, second and third elongated members are made of a single material and of a single structure, for example a precious metal chain.

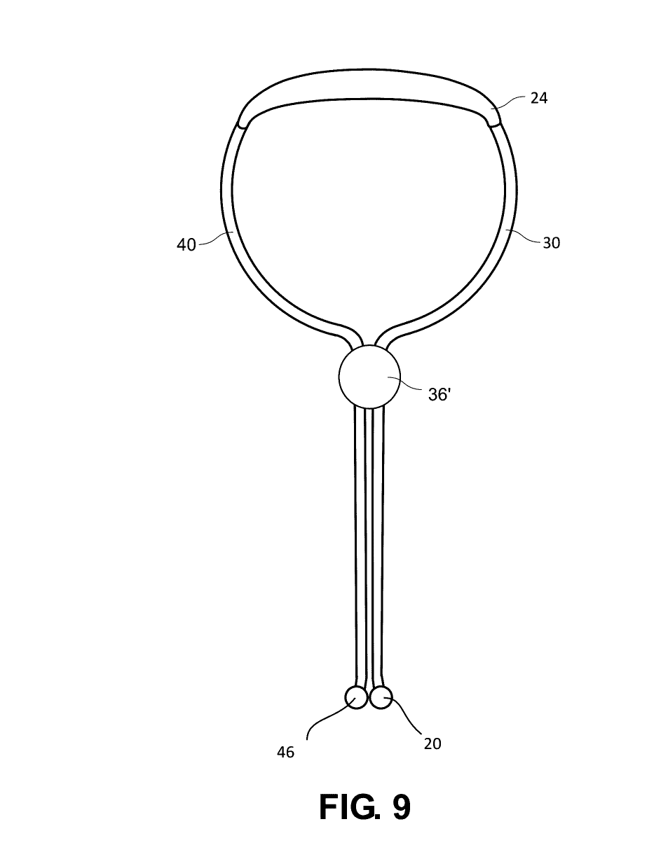

FIG. 9 schematically represents a ring 8 according to an embodiment of this presentation, where the first elongated element 24 does not have a same structure as the second 30 and third 40 elongated elements, and actually comprises a rigid metal structure. The rigid metal structure can be flat or curved. The rigid metal structure can carry one or more stones and or some enameled portions. The rigid metal structure can have various shapes, for example in a plane perpendicular to the figure, such as stylized hearts, clover, horseshoe, etc. . . .

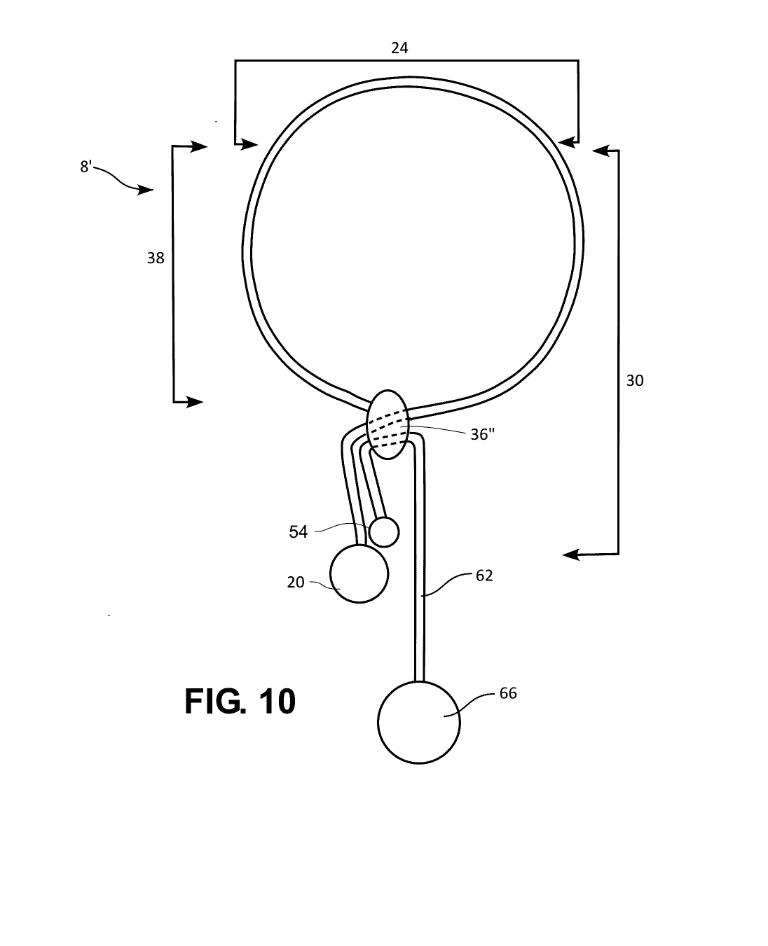

FIG. 10 schematically represents a ring 8′ according to an embodiment of this presentation that comprise a first elongated member 24; a second elongated member 30 attached to bead 20, and a flexible section 38 identical to those described in relation with FIG. 3. According to an embodiment of this presentation ring 8′ comprises a slider 36″ having a first lumen through which second elongated member 30 frictionally slides, as described with respect to slider 36 of FIG. 3. Further, slider 36″ comprises an additional lumen through which an additional flexible elongated member 62 slides in a frictionally restrained manner. According to an embodiment of this presentation, additional first 64 and second 66 beads are attached respectively to first and second ends of the additional flexible elongated member 62. According to an embodiment of this presentation, bead 20 as well as additional first bead 64 can be small and light, while additional second bead 66 can be larger and heavier, wherein the structure illustrated in FIG. 10 allows changing the effective diameter of ring 8′ without changing the distance between additional second bead 66 and ring 8′, and also allows changing distance between additional second bead 66 and ring without changing the 8/the effective diameter of ring 8′. Additional flexible elongated member 62 can be of the same material and structure as the second elongated member 30.

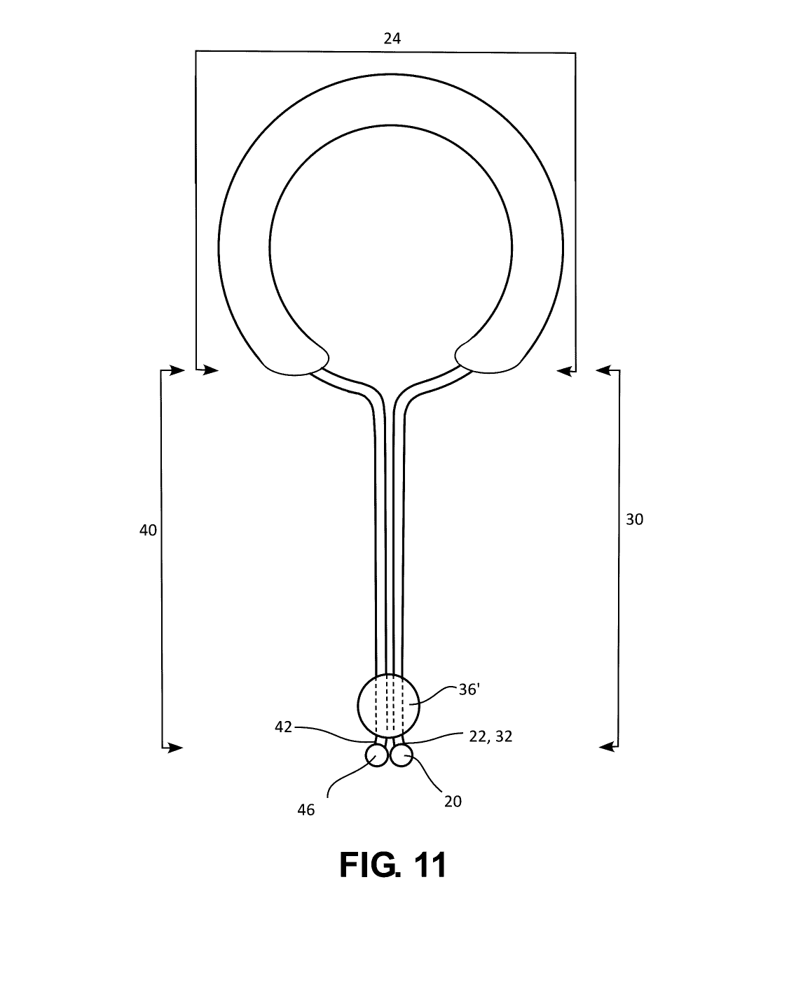

FIG. 11 schematically represents a ring according to an embodiment of this presentation, where the first elongated element 24 does not have a same structure as the second 30 and third 40 elongated elements, and actually comprises a flexible metal structure such as a chain of different diameter than the second 30 and third 40 elongated elements.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art.

No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for. . .” and no method or process step herein is to be construed under those provisions unless the step, or steps, are expressly recited using the phrase “comprising the step(s) of . . . .”

What is claimed is:

1. An adjustable jewelry ring comprising:
a first elongated member having a first length between opposite first and second ends;
a second elongated member having a second length between opposite first and second ends, the second end of the second elongated member being attached to the first end of the first elongated member and the first end of the second elongated member being attached to a first bead; the second elongated member being flexible;
a third elongated member having a third length between opposite first and second ends, the second end of the third elongated member being attached to the second end of the first elongated member and the first end of the third elongated member being attached to a second bead;
a slider coupling the second and third elongated members, arranged to be independently slidable to any position along the lengths of each of the second and third elongated members;
wherein the combined lengths of the first, second and third elongated members is comprised between 50 and 150 millimeter.

2. The adjustable jewelry ring of claim 1, wherein the slider comprises a friction element for retaining the slider to the position it is slid to along the lengths of the second or third elongated members

3. The adjustable jewelry ring of claim 1, wherein at least one of the first and second beads has a weight comprised between 0.4 and 2 grams.

4. The adjustable jewelry ring of claim 1, wherein the first and second beads are beads made of precious or non-precious metal.

5. The adjustable jewelry ring of claim 1, wherein the second and third elongated members are made of precious or non-precious metal.

6. The adjustable jewelry ring of claim 5, wherein the second and third elongated members each comprise a length of chain.

7. The adjustable jewelry ring of claim 1, wherein the first elongated member comprises a length of precious or non-precious metal chain.

8. The adjustable jewelry ring of claim 1, wherein the first elongated member is a rigid metal structure.

9. The adjustable jewelry ring of claim 1, wherein the second and third elongated members have each a cross-section having a largest dimension comprised between 0.6 and 3 millimeter.

10. The adjustable jewelry ring of claim 1, wherein the slider has a height, a width and a length; the second and third elongated members passing through at least one lumen traversing the slider along its length.

11. The adjustable jewelry ring of claim 10, wherein the friction element comprises a resilient element arranged in the at least one lumen.

12. A method of relieving stress, comprising:
securing around a phalange of a finger of a hand of a user a ring having attached to it a first end of a flexible element, a first bead being attached to a second end of the flexible element, such that when the hand is held vertical with the finger upright the first bead touches a predetermined region of the finger or the hand;
wherein the ring has an adjustable circumference length and can be secured around any phalange of any finger of the hand.

13. The method of claim 12, wherein said ring comprises:
a first elongated member having a first length between opposite first and second ends;
a second elongated member having a second length between opposite first and second ends, the second end of the second elongated member being attached to the first end of the first elongated member and the first end of the second elongated member being attached to said first bead; the second elongated member being flexible;
a slider arranged for being slidable to any position along the length of the second elongated member;
wherein the slider is coupled to the second end of the first elongated member; and
wherein said flexible element is formed by the second elongated member between said bead and said slider.

14. The method of claim 13, wherein the slider comprises a first friction element for retaining the slider to the position it is slid to along the length of the second elongated member

15. The method of claim 14, wherein the slider is coupled to the second end of the first elongated member by:
a third elongated member having a third length between opposite first and second ends, the second end of the third elongated member being attached to the second end of the first elongated member and the first end of the third elongated member being attached to a second bead; the third elongated member being flexible; wherein the slider is arranged for being slidable to any position along the length of the third elongated member;
wherein the combined lengths of the first, second and third elongated members is comprised between 50 and 150 millimeter.

16. The method of claim 15, wherein the slider comprises a second friction element for retaining the slider to the position it is slid to along the length of the third elongated member.

17. The method of claim 12, wherein the first bead has a weight comprised between 0.4 and 2 grams.

18. The method of claim 15, wherein the first and second beads are beads made of precious or non-precious metal.

19. The method of claim 15, wherein the second and third elongated members are made of precious or non-precious metal.

20. The method of claim 19, wherein the second and third elongated members each comprise a length of chain.

21. The method of claim 13, wherein the first elongated member comprises a length of precious or non-precious metal chain.

22. The method of claim 13, wherein the first elongated member is a rigid metal structure.

23. The method of claim 15, wherein, wherein the second and third elongated members have each a cross-section having a largest dimension comprised between 0.6 and 3 millimeter.

24. The method of claim 15, wherein the slider has a height, a width and a length; the second and third elongated members passing through at least one lumen traversing the slider along its length.

25. The method of claim 16, wherein one of the first and second friction elements comprises a resilient element arranged in the at least one lumen.
